(19) United States
(12) Patent Application Publication
(10) Pub. No.: US 2022/0268299 A1
(43) Pub. Date: Aug. 25, 2022

(54) HYDRAULIC CONTROL DEVICE IN ROLLING MILLS

(71) Applicant: SMS GROUP GMBH, Düsseldorf (DE)

(72) Inventors: Andreas LÖHR, Herdorf (DE); Frank-Günter BENNER, Hilchenbach (DE); Sandra WIED, Bad Laasphe (DE); Markus PRINZ, Netphen (DE); Stephan STÄCKER, Kreuztal (DE); Mark STENSKE, Siegen (DE); Valentin TRIEBUS, Hilchenbach (DE)

(73) Assignee: SMS GROUP GMBH, Düsseldorf (DE)

(21) Appl. No.: 17/618,223

(22) PCT Filed: Jun. 2, 2020
(86) PCT No.: PCT/EP2020/065205

§ 371 Date: Dec. 10, 2021

(30) Foreign Application Priority Data
Jun. 12, 2019 (DE) 10 2019 208 495.8

(51) Int. Cl. F15B 13/08; B21B 31/00

(52) U.S. Cl. CPC F15B 13/0814; B21B 31/00; F15B 13/0885

(57) ABSTRACT

A control unit for a distributor network of liquid and/or gaseous media, in particular for a roll stand, a media module, and a roll stand. The control unit has: a base plate having one or more media transport lines of the distributor network, which extend at least in sections in the plane of the base plate; and one or more functional blocks having an internal piping and one or more control elements having a functional connection thereto. The functional blocks are configured to be installable on the base plate so that the internal piping has a fluid connection to one or more of the media transport lines, and to be detachable from the base plate.

### FIELD

The invention relates to a control unit for a distributor network of hydraulic and/or pneumatic operating media, in particular in rolling mill construction. The invention furthermore relates to a media module having such a control unit and a roll stand.

### BACKGROUND

Control units for distributor networks of hydraulic and/or pneumatic operating media, which ensure access to valves, valve groups, and other positioning elements (jointly referred to as “control elements” hereinafter) and enable the actuation thereof, are usually implemented in a panel construction or column construction. They enable the operation and maintenance of a distributed network for liquid or gaseous media, for example, lubricants and coolants, and also hydraulic or pneumatic pressure media for positioning elements and drives. Such distributor networks having control unit(s) are used in metal processing, in particular in rolling mill construction.

In the panel construction of a control unit, the individual control elements are assembled on a panel, which can be arranged vertically or horizontally. The control elements can be arranged comprehensibly, for example, in functional groups, but since the position and orientation of the control elements are predefined by the panel plane, the hydraulic/pneumatic connection thereof is linked to a significant piping expenditure on the rear side of the panel. The risk of potential leak points in the form of piping elements and joints thus increases. Moreover, the control elements are difficult to access on the rear side of the panel, whereby the installation and maintenance thereof is complex.

Starting from the panel construction, one development step in the construction of control units was to assemble the control units into functional units and to form control blocks. The feed, discharge, and distribution lines and also the control elements are housed in a control block. The piping may thus be reduced in comparison to the panel construction, since the control block only has to be equipped with the lines associated with the functional unit.

The control blocks fall under the column construction, in which the control elements are arranged essentially vertically. In this case, this can be a stack of individual control blocks or a continuous control column, on which the control elements are individually fastened. The smaller space requirement and a reduction of the piping in comparison to the panel construction are advantageous in the column construction. Nonetheless, the piping expenditure is still significant. This also applies for the installation and maintenance work.

As mentioned above, the column construction can be divided into a continuous construction and a construction having multiple stacked blocks. In the latter case, possible leak surfaces result between the joints of the control blocks, which are technically complex to seal reliably. To avoid possible leaks, lag screws are used between the plates. However, these either have a disadvantageously short clamping length or, in the case of longer, continuous tie rods, display an undesired longitudinal extension, which promotes leaks. This construction also has the disadvantage that the entire valve station has to be taken out of operation in the event of a replacement or maintenance of the controller, in order to replace individual control blocks. The entire stack has to be removed for this purpose to reach the corresponding assemblies.

In the continuous column construction, individual control elements are possibly installed grouped on a continuous column. The problem of leaks on the column itself is thus remedied. However, especially in the case of grouped units, only fasteners having short clamping length can be used, i.e., the critical interfaces are merely displaced. The improved maintainability and replaceability are advantageous, but an increased piping expenditure is required, since the space in the cross section of the column becomes scarce with increasing height of the control column. This has the result that lines possibly have to be led and connected outside the column.

An arrangement of feed, discharge, and distributor lines and also control elements of a distributor network in column construction is disclosed in EP 1 100 634 B1.

Therein, the distributor network has pipeline groups and a central control station connected to the pipeline groups in a media stage of a roll stand. Pipe routes are located on the stand upper side and also on stand side walls or stand pillars. These pipe routes along the roll stand support, for example, the P line (pressure line) and the T line (tank line), which lead from and to the pump station, energy supply, power unit), and supply actuators of the roll stand with oil. The pump station is usually located in the cellar below the roll stand. The operation and maintenance of the distributor network essentially takes place at control units in column construction, which are located in or below the above-mentioned media stage.

In the media stage, consisting of steel construction and the hydraulic controllers, so-called “pockets” are arranged, in which the hydraulic controllers are housed with the pressure accumulators. These pockets are closed spaces having covered hatch and ladder, through which the maintenance personnel have to enter to perform the maintenance.

The maintenance and operation of the control elements usually takes place at least partially in so-called “confined spaces”, which can entail complex safety regulations. It can thus be necessary, for example, to place a second person at the hatch outside the confined space to secure the maintenance person working therein, who is possibly roped up.

Overall, all above-described distributor networks having control unit(s) have the disadvantage of many potential leak points in the form of piping elements and joints. This is particularly problematic in the technical area of metal processing, in particular rolling mill technology, since contamination, for example, of the roll and/or strip coolant or lubricant (emulsion, water, roll oils, kerosene) with hydraulic medium can result in surface flaws of the rolled stock. Avoiding hydraulic leaks thus has significant importance for the surface quality of the rolled stock.

Furthermore, problems with respect to the maintenance result from the predominantly vertical arrangement of the control elements, since the columns (but also the panels) can be several meters tall. In the case of high hydraulic pressures, for example, of approximately 375 bar, many potential leak points are to be monitored and maintained for the leak-tightness of the system, with only limited maintenance friendliness.

The significant piping expenditure moreover contributes not insignificantly to the total weight of the facility. High transport costs, and possibly heavy transports, are thus required. The costs, the work effort, and the construction time for manufacturing and assembling the facility on the construction site cannot be readily reduced using the conventional constructions.

### SUMMARY

One object of the invention is to improve the control of distributor networks of hydraulic and/or pneumatic operating media, particularly preferably in rolling mill construction, in particular by overcoming at least one of the above-mentioned disadvantages.

The object is achieved by a control unit, a media module, and a roll stand.

The control unit according to the invention is configured for a distributor network of liquid and/or gaseous media, in particular for use in metal-processing facilities. The control unit is particularly preferably used in rolling mill construction. The control unit is thus preferably a fluidic control unit and/or supply unit in rolling mill construction. For example, the control unit can be used for hot rolling or cold rolling stands for the rolling processing of steel or NF metals (nonferrous metals). The distributor networks connectable thereto transport operating media, such as lubricants and coolants, hydraulic and/or pneumatic pressure media for positioning elements, drives, and the like.

The control unit has: a base plate having one or more media transport lines of the distributor network, which extend at least in sections in the plane of the base plate; and one or more functional blocks having internal piping and one or more control elements functionally connected thereto, wherein the functional blocks are configured to be installable on the base plate so that the internal piping has a fluid connection to one or more of the media transport lines, and to be detachable from the base plate. The base plate is normally to be installed horizontally or essentially horizontally.

The spatial designations “horizontal”, “vertical”, “above”, “below”, and the like are uniquely defined by the installation position of the control unit, in particular of the facility having the distributor network, and are generally to be viewed relative to the direction of gravity. Furthermore, the designation “fluid connection” means that a fluid, i.e., the relevant hydraulic or pneumatic operating medium, can flow between the components having a fluid connection. This does not preclude an interconnection of components which can suppress the fluid transport, such as valves. The designations “installable”, “detachable”, etc. relate to the intended use; thus, for example, a forceful, destructive separation does not fall under the designation “detachable”.

Since the functional blocks are installable on the base plate along two axes and the functional blocks in turn have multiple sides, for example five cube sides, for connecting control elements, a large number of connections and branches can be produced without additional fittings and pipes. The number of potential leak points is thus reduced. A more extensive supply can thus be provided using the base plate than is possible, for example, using a vertical control column or control panel.

The control unit is accordingly a modularly constructed installation unit of fluidic technology and piping technology. In addition to improved configurability, installability, and expandability, the technical solution is space-saving and has particularly few pipes. The construction and operational reliability are thus strengthened. The manufacturing demands can be reduced, and the comprehensibility of the control elements and the functionality are increased. The maintenance expenditure is reduced. A targeted shutoff of selected functions is possible with minimal material and work expenditure and without additional piping inside the control unit. The structure of the functional blocks can also be standardized. The modular structure of the control unit moreover enables a disassembly of the facility suitable for containers, whereby the transport can be carried out in a rapid and resource-efficient manner without possible heavy transports.

The above-mentioned technical effects moreover contribute to reducing possible leak points. Cooling lubricants, water, and the like are stressed less. The cleaning expenditure decreases. External piping can be omitted, since each function can be supplied with a pressure medium by internal bores.

Due to the modular structure of the control unit, possible leaks which nonetheless occur may be assigned precisely to the affected functional block, whereby accurate maintenance and repair can be carried out. Other functional blocks which are not affected do not have to be removed and possibly do not even have to be shut down, whereby the facility can continue to run in the latter case.

The technical solution described herein moreover permits all conceivable fluids which can occur in the rolling mill, comprising the oil-air lubrication of the working roller bearings, to be covered and to be distributed in an ordered manner in the media module described below.

The base plate and/or an intermediate plate arranged between the functional blocks and the base plate preferably has multiple openings which are configured to screw together the functional blocks by means of fastening screws, preferably lag screws. To replace the functional blocks, the screw connection between the functional blocks and the base plate or intermediate plate is detached, and the relevant functional block can be raised. No additional connecting pipelines and the like have to be taken into consideration during this work. The adjacent functional blocks remain untouched in their function and position. The above-mentioned intermediate plate, which is used for fastening the functional blocks or assists this fastening, can be inserted if needed between the functional blocks and the base plate. The complexity of the bores in the base plate can thus be reduced, since the screw bores and the bores for connecting lines of the relevant functional block are thus adaptable to the base plate. Fastening screws, which are preferably implemented as strong lag screws, connect the base plate and the intermediate plate without leaks in this case.

The control elements preferably comprise valves and/or actuating elements thereof. The modular concept described herein permits a comprehensible grouping of valves without the piping expenditure thus increasing.

The media transport lines in the base plate preferably comprise one or more supply lines and one or more removal lines which are configured to transport the corresponding media from a main supply to the functional blocks and from there to consumers, such as positioning elements, adjusting cylinders, drives, etc. In that the supply line(s) and removal line(s) extend horizontally in the plane of the base plate, the pipes of the functional blocks can branch off directly therefrom upward out of the plane of the base plate, whereby the piping expenditure is minimized.

The media transport lines are preferably embedded at least in sections in the base plate, whereby the modularity and installability of the control unit are further improved.

The base plate and the functional blocks are preferably modularly constructed in such a way that the functional blocks are configurable differently on the base plate, whereby the applicability is made more flexible and at the same time the work expenditure for the manufacturing and assembly of the connecting pipelines on the construction site can be reduced.

The above-mentioned object is furthermore achieved by a media module which is configured to operate a distributor network of liquid and/or gaseous media, in particular in rolling mill construction. The designation “operation” comprises in this case control, regulation, maintenance, monitoring, and the like. The media module has one or more control units according to one or more of the above-described embodiment variants.

The features, technical effects, advantages, and exemplary embodiments which were described with respect to the control unit apply similarly to the media module.

The media module is particularly preferably implemented as a media stage. The media stage can be an open space having safety railings and one or more accesses, via which the maintenance personnel can step on the media stage, for example, via a ladder, for example when the media stage is placed on a roll stand. However, the media module can also be constructed in another way. The media module can thus be, for example, a ground-level control center having one or more control units, an open or closed control space having one or more control units, and the like.

The media module preferably furthermore has an energy supply device. The energy supply device preferably has at least one pump and at least one media container for supplying one or more consumers. Furthermore, the energy supply device can comprise filters, a heater and/or a cooler, or the like. In other words, according to this exemplary embodiment, the media module has a pump station, whereby an external energy supply, for example, in the cellar below the facility, and lines and pipe routes therein can be dispensed with. The media module is autonomously functional and is therefore particularly flexibly applicable and is installable with reduced work expenditure.

The control unit described herein and the media module is equipped therewith are particularly preferably used in the rolling mill, for example as a component of a roll stand. The above-mentioned object is thus also achieved by a roll stand having a media module according to one of the above-described embodiment variants.

The features, technical effects, advantages, and exemplary embodiments which were described with respect to the control unit and the media module apply similarly to the roll stand.

The media module is preferably fastened on one or more roll supports of the roll stand, particularly preferably above rolls supported by the roll supports. The media module is preferably screwed onto the roll supports. The media module does not necessarily have to be placed on top on the supports of the roll stands in this case, but can be fastened on the operating side and drive side on the vertical surfaces of the supports or support pillars, preferably on the stand outside but not necessarily exclusively there. The height of the media module can be selected flexibly in this way.

Alternatively, the media module can be mounted decoupled from the roll stand, preferably on separate supports, which are fastened, for example in the foundation of the facility. This prevents oscillations and shocks of the mechanism, for example in the event of broaching processes or strip thickness changes, from being introduced into the media module and thus into the sensitive valve technology.

Alternatively, the media module can also be placed on supports of possible other media modules, for example side wall modules, or fastened thereon. These other media modules or side walls can then in turn stand on the foundation and thus also decouple the roll stand from the media module, whereby the possible side wall modules are additionally also decoupled.

The media module, in particular in the construction of a media stage, can thus be secured completely decoupled on supports on the foundation. The vibrations in the roll stand are thus not passed on to the valve technology. The valves are protected and their lifetime is lengthened. An attachment via supports to the foundation can also only be partially provided, however. For example, cantilevers can be attached to the supports of the roll stand, wherein supports down to the foundation are only provided in front.

Due to the installation forms mentioned here, the level of the media module can be brought flexibly at the technologically optimal height to the consumers, since the media module, in particular in the construction of a media stage, can be “pulled” via the supports of the roll stand and fixed in any vertical position. The ideal height of the media module, for example based on experiential values or ascertained by simulation, permits the hydraulic and/or pneumatic paths to be kept sufficiently short to achieve good dynamics between control element (valve) and the element to be controlled (cylinder, motor, etc.).

Moreover, a second level having saddlebags to place the media stage on the supports and simultaneously to get as close as possible to the critical consumers, is not necessary. The requirement for the operating personnel to have to climb back and forth between two levels via ladder in order to reach the controllers is thus dispensed with. A decentralized arrangement of control elements, such as valves, outside the media module, in particular at points which are difficult to access, can thus possibly be completely dispensed with.

Due to the flat construction of the control unit, it is particularly suitable for installation on a media stage of a roll stand. The control elements, which are conventionally arranged on multiple levels with comparatively poor accessibility due to the structural height of the control columns, are arranged in a comprehensible and easily accessible manner in this way. Pipelines possibly obstructing the accessibility can be dispensed with. The resulting overall stage height can be less. The work safety can be significantly improved in that confined hydraulic spaces and the work therein can be dispensed with. Possible safety precautions and the costs linked thereto can be reduced.

Machine piping in the stand region and on the media stage can be significantly reduced, in that the modularly constructed media stage itself is arranged as a module on the roll stand. The media stage can be arranged and fastened on the typically four support pillars of the roll stand on the stand outer side, whereby the pipelines from the control elements to the consumers can be shortened and a significantly lower piping expenditure is implementable overall. Laying and bundling the control elements on the media stage saves the distance from the stand center to the support pillars as a piping section.

For this purpose, girders for fastening the media stage can be flanged onto the supports of the roll stand, whereby the media stage can be placed particularly low. A low overall structural height and a technologically very close attachment location of the control elements to the consumers, such as adjusting cylinders of the rolls, are thus implementable, without the maintenance personnel having to negotiate in confined spaces directly at the consumers, for example having to climb down from the media stage through a hatch. A sufficient freedom of movement and thus an increase in safety are always given by the open design in the case of a media stage equipped with the control units.

Due to the low construction of the media stage, all control elements can moreover be arranged centrally on the media stage, since the hydraulic/pneumatic path lengths can be kept short. The precise positions of the control unit(s) and media stage can be ascertained by simulation, so that the dynamics between control valve and the consumer can be set optimally.

The reduction of the piping expenditure moreover results in a lower weight of the overall facility, which contributes to an increase in cost-effectiveness both in the installation and also in operation. Together with the comparatively low design, the resulting facility, thus also linked thereto the hall size, etc., may be more compact. The costs and the work expenditure for the manufacturing and assembly of the connecting pipelines on the construction site can be reduced. This is further assisted by a possible integration of the energy supply device.

In addition to the described control and energy supply functions, the media module, in particular in the embodiment of the media stage, can comprise further functions. The media module can thus also be used as a carrier of further elements which were originally associated with the mechanism of the roll stand.

A hoist can thus be integrated in the media module or attached thereon to transport loads, for example for maintaining the roll stand. A step wedge and/or sling or installation points for attaching a sling can be provided, which can be used, for example, for installation or maintenance work in the roll stand. For the same purpose, the media module can have an integrated step tread extension device.

Support crossbeams can be integrated on the media module, which are in turn usable as girders of various functionality. If the support crossbeams are embodied as hollow girders, they can function synergistically, for example, as a suction channel, water connection, and/or distributor pipe for the roll cooling in the case of hot strip facilities.

Furthermore, safety devices, such as fire extinguishing devices, can be integrated in the media module.

Further advantages and features of the present invention are apparent from the following description of preferred exemplary embodiments. The features described therein can be implemented alone or in combination with one or more of the above-described features if the features do not contradict one another. The following description of the preferred exemplary embodiments is carried out with reference to the appended drawings.

### BRIEF DESCRIPTION OF THE FIGURES

FIG. 1 is a schematic cross-sectional view of a control unit for a distributor network of liquid and/or gaseous operating media.

FIG. 2 is a perspective view of an exemplary control unit having a plurality of functional blocks.

FIG. 3 is a perspective view of a media module configured as a media stage having control units on a roll stand.

FIG. 4 is a perspective view of a media module configured as a media stage having reduced structure and base plate shown as transparent.

FIG. 5 is a perspective view of a media module configured as a media stage, equipped with an energy supply device.

### DETAILED DESCRIPTION

Preferred exemplary embodiments are described hereinafter on the basis of the figures. Identical, similar, or identically acting elements are provided with identical reference signs, and a repeated description of these elements is partially omitted to avoid redundancies.

FIG. 1 is a schematic cross-sectional view of a control unit 10 for a distributor network of liquid and/or gaseous operating media, in particular for a roll stand.

The control unit 10 has a base plate 11 and multiple functional blocks 12, which are installable by means of fastening screws 13 (only schematically shown by the center lines thereof in FIG. 1) on the base plate 11 and are detachable therefrom. For this purpose, the base plate 11 is preferably penetrated by a plurality of bores (not shown for the sake of comprehensibility in the figures), which enable a flexibly configurable arrangement of functional blocks 12. A functional block 12 is shown raised for maintenance and/or repair purposes in FIG. 1.

It is to be noted that the functional blocks 12 do not necessarily have to be designed as cubical or cuboid, although this can be advantageous with regard to possible standardization.

The base plate 11 is to be arranged essentially horizontally and in its plane guides one or more media transport lines 11a of a distributor network for liquid and/or gaseous operating media, such as lubricants and coolants, hydraulic and/or pneumatic pressure media for positioning elements, drives, and the like. The media transport lines 11a comprise, for example, feed, discharge, and/or distributor lines. Supply lines and removal lines (for example P, T, X, Y, A, B fittings) are particularly preferably comprised and embedded in the base plate 11, which conducts the corresponding media from a main supply to the functional blocks 12 and back in the direction of the consumers. The main supply and the individual consumers are not shown in the figures.

The functional blocks 12 each have an internal piping 12a and control elements 12b, preferably valves, valve groups, or actuating elements thereof. The piping 12a of the functional blocks branches upward out of the plane of the base plate 11. In other words, the functional blocks 12 are configured to be installable on the base plate 11 so that the internal piping 12a has a fluid connection to one or more of the media transport lines 11a, and to be detachable from the base plate 11. The installation and removal of the functional blocks 12 on the base plate 11 is preferably carried out by the above-mentioned screw connection using the fastening screws 13, which have a sufficient clamping length.

Since the functional blocks 12 are installable on the base plate 11 along two axes and the functional blocks 12 in turn have multiple sides, for example five cube sides, for connecting control elements 12b, a large number of connections and branches can be produced without additional fittings and pipes. Possible leak points are thus reduced. A more extensive supply can thus be provided using the base plate 11 as the base and the configurable functional blocks 12 than is possible, for example, using a vertical control column or control panel.

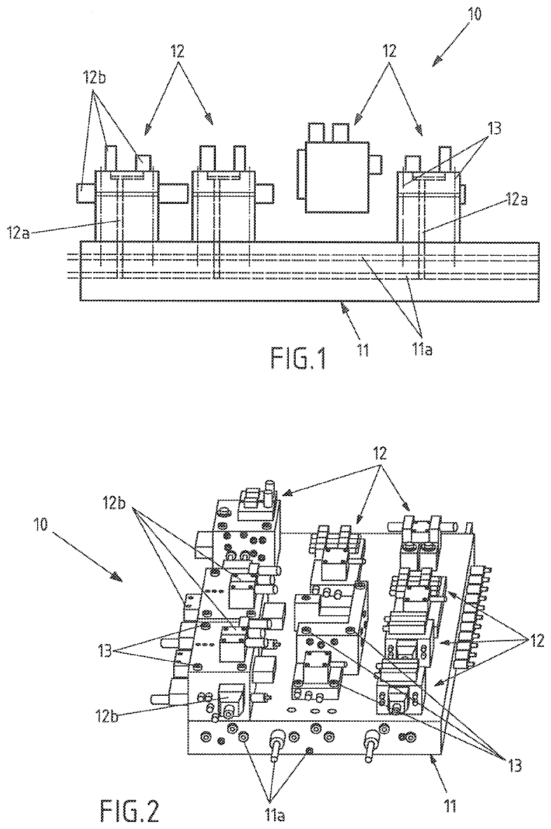

A more detailed exemplary structure of a control unit 10 having a plurality of functional blocks 12 is shown in the perspective illustration of FIG. 2. The functional blocks 12 are preferably constructed and usable modularly, i.e., a plurality of hydraulic/pneumatic interconnections may be implemented using prefinished and/or preconfigured functional blocks 12.

The control unit 10 itself can also be constructed modularly. FIG. 2 thus shows a control unit module, which can also be referred to as a “control plate”, having a base plate 11 and a plurality of functional blocks 12 screwed thereon.

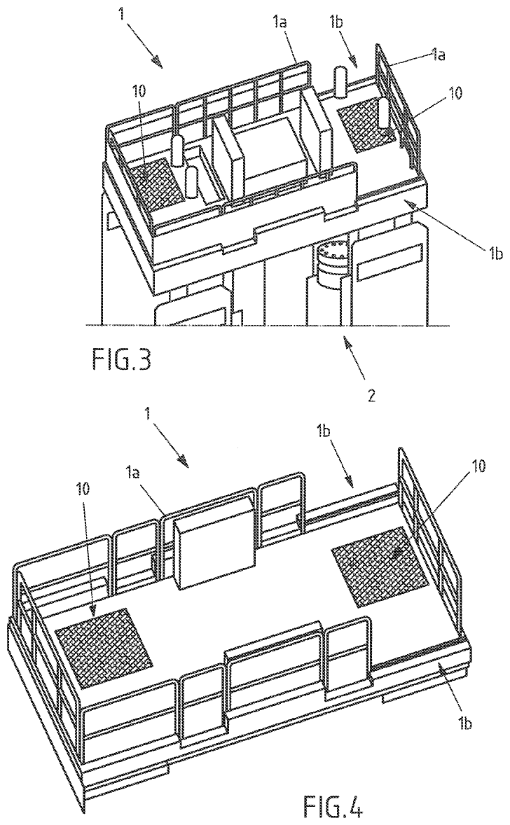

One or more of these control units 10 can now be used or installed, for example, in a media module 1, as shown in FIG. 3.

The media module 1 is implemented by way of example in FIG. 3 as a media stage. The media stage itself is an open space having safety railing(s) 1a and one or more accesses 1b, via which the maintenance personnel can step onto the media stage, for example, via ladders (not shown in the figures), for example when the media stage is placed on a roll stand 2.

It is to be noted that the media module 1 can also be constructed in another way. The media module 1 can thus be a ground-level control center having one or more control units 10, an open or closed control room having one or more control units 10, etc.

In FIG. 4, the media module 1 embodied as a media stage is shown in a perspective view from above, wherein the media module 1 is shown in a reduced structure and the base plate thereof is shown transparent to make supply lines visible, such as feed, discharge, and/or distributor lines, for a distributor network of the roll stand 2.

The media module 1 is preferably screwed onto the roll supports of the roll stand 2. Alternatively, the media module 1 can be mounted decoupled from the roll stand 2, preferably on separate supports, which are fastened, for example, in the foundation of the facility. This prevents oscillations and shocks of the mechanism, for example in the event of broaching processes or strip thickness changes, from being introduced into the media module 1 and thus into the sensitive valve technology. Alternatively, the media module 1 can also be placed on supports of possible other media modules, for example side wall modules, or fastened thereon. These other media modules or side walls can then in turn stand on the foundation and thus also decouple the roll stand from the media module 1, wherein the possible side wall modules are additionally also decoupled.

The media module 1, in particular in the construction of a media stage, as shown in FIGS. 3 to 5, can thus be secured completely decoupled on supports on the foundation. Vibrations in the roll stand are thus not passed on to the valve technology. The valves are protected and their lifetime is lengthened. However, an attachment via supports to the foundation can also only be partially provided. For example, cantilevers can be attached to the supports of the roll stand, wherein supports down to the foundation are only provided in front.

The level of the media module 1 can be brought flexibly at the technologically optimal height to the consumers by the installation forms mentioned here, since the media module 1, in particular in the construction of a media stage, can be “pulled” via the supports of the roll stand and fixed in any vertical position. The ideal height of the media module 1, for example based on experiential values or ascertained by simulation, permits the hydraulic and/or pneumatic path to be kept sufficiently short to optimize the dynamics. Moreover, a second level having saddlebags to place the media stage on the supports and to move as close as possible to the critical consumers at the same time is not necessary. The necessity for operating personnel to have to climb back and forth between two levels via ladder in order to reach the controllers is thus dispensed with. A decentralized arrangement of control elements, such as valves, outside the media module 1, in particular at points which are difficult to access, can thus possibly be completely dispensed with.

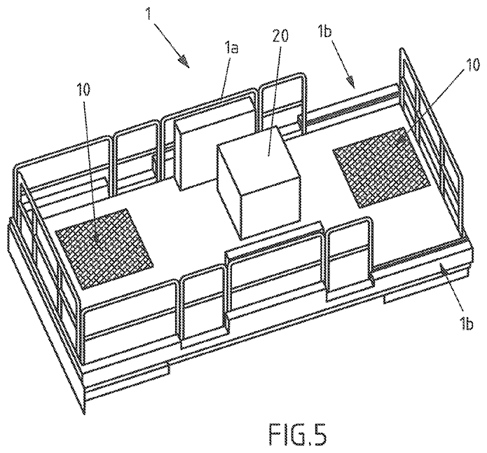

FIG. 5 shows the media module 1 of FIG. 4 equipped with an energy supply device 20, also referred to as a “power unit”, which is arranged by way of example here essentially centrally in the inner region of the media module 1. The energy supply device 20 preferably comprises at least one pump and at least one container having the corresponding operating medium for the independent supply of one or more consumers. Furthermore, the energy supply device 20 can comprise filters, a heater, and/or a cooler. In other words, according to this exemplary embodiment the media module 1 comprises a pump station, whereby an external energy supply, for example in the cellar below the facility, and lines and pipe routes therein can be omitted. The media module 1 is autonomously functional and is thus particularly flexibly usable and is installable with reduced work expenditure.

The control unit 10 described herein, and the media module 1, which has one or more such control units 10, are installation units of fluidic technology and piping technology modularly constructed on multiple levels. In addition to improved configurability, installability, and expandability, the technical solution is space-saving and has particularly few pipes. The construction safety and operational safety are thus strengthened. The manufacturing demands are reduced, and the comprehensibility of the control elements 12b and the functionality are increased. A targeted shutdown of selected functions is possible with minimal material and work expenditure and without piping inside the control unit 10. The structure of the functional blocks 12 can also be standardized. The modular structure moreover enables disassembly of the facility suitable for containers, whereby the transport can be carried out in a rapid and resource-efficient manner without heavy transports.

The above-mentioned technical effects moreover contribute to a reduction of possible leak points. Coolant lubricants, water, and the like are potentially stressed less. The cleaning expenditure sinks. External piping can be omitted, since each function can be supplied with pressure medium by internal bores.

Due to the modular structure of the control unit 10 and the media module 1, leaks which possibly still occur may be assigned to precisely the respective functional block 12 or the respective control unit 10, whereby accurate maintenance and repair can be carried out. Other functional blocks 12 or control units 10 which are not affected do not have to be removed and possibly do not even have to be shut down, whereby the facility can continue to run in the latter case.

To change functional blocks 12, the screw connection between the functional blocks 12 and the base plate 11 is detached, and the relevant functional block 12 can be raised. No additional connecting pipelines or the like have to be taken into consideration during this work. The adjacent functional blocks 12 remain untouched in their function and position.

Due to the flat arrangement, separate P & T bores can be provided for each functional block 12. This permits isolated switching, in particular switching off, of controllers or control functions.

Climbing aids or special safety equipment are not required for the maintenance.

An intermediate plate, which is used for the fastening of the functional blocks 12 or assists it, can be inserted if needed between the functional blocks 12 and the base plate 11. The complexity of the bores in the base plate 11 can thus be reduced, since the screw bores and the connecting lines of the relevant functional blocks 12 are thus adaptable to the base plate 11. Fastening screws 13, which are preferably implemented as strong lag screws, connect the base plate 11 and the intermediate plate without leaks in this case.

A collecting device, such as a trough, can be provided for possibly occurring residual leaks.

The control unit 10 described herein, and the media module 1 equipped therewith, are preferably used in metal processing, particularly preferably especially in rolling mills.

This is because due to the flat construction, the control units 10 are particularly suitable for hydraulic controllers, which are arranged on a media stage. The media stage can be arranged above the stand supports. The control elements, which are conventionally arranged on multiple levels due to the structural height of the control columns and have comparatively poor accessibility, are arranged in a comprehensible and easily accessible manner in this way. Pipelines possibly obstructing the accessibility can be omitted. The resulting stage height can be less overall. The work safety can be significantly improved in that confined hydraulic spaces and the work therein are omitted. Possible safety precautions and the costs linked thereto can be reduced.

Machine piping in the stand region and on the media stage can be significantly reduced in that the modularly constructed media stage itself is arranged as a module on the roll stand 2. The media stage can be arranged and fastened on the typically four support pillars of the roll stand 2 on the stand outer side, so that the pipelines from the control elements 12b up to the consumers can be shortened and a significantly lower piping expenditure is implementable overall. The laying and bundling of the control elements 12b on the media stage conserves the distance from the stand center to the support pillars as a piping section.

For this purpose, girders for fastening the media stage can be flanged onto the supports of the roll stand, whereby the media stage can be placed particularly low. A low overall structural height and an attachment location of the control elements 12b technologically very close to the consumers, such as adjusting cylinders of the rolls, are thus implementable, without the maintenance personnel having to negotiate confined spaces directly at the consumers, for example climb down from the media stage through a hatch. A sufficient movement freedom and thus an increase in safety are always given by the open structure in the case of a media stage equipped with the control units 10.

The reduction of the piping expenditure additionally results in a lower weight of the overall facility, which contributes to increasing cost-effectiveness both in installation and also in operation. Together with the comparatively low structure, the resulting facility, also linked thereto the hall size etc., can be more compact. The costs and the work expenditure for the manufacturing and installation of the connecting pipelines on the construction site can be reduced. This is further assisted by a possible integration of the energy supply device 20.

In addition to the described control and energy supply functions, the media module 1, in particular in the embodiment of the media stage according to FIGS. 3 to 5, can comprise further functions. The media module 1 can thus also be used, for example, as a carrier of further elements which were originally associated with the mechanism of the roll stand 2.

For example, a hoist can be integrated on the media module 1 or attached thereon to transport loads, for example for maintenance of the roll stand 2. A step wedge and/or sling or installation points for attaching slings can be provided, which can be used, for example, for installation or maintenance work in the roll stand 2. The media module 1 can have an integrated step tread extension device for the same purpose.

Support crossbeams can be integrated on the media module 1, which are in turn usable as girders of various functionality. If the support crossbeams are embodied as hollow girders, they can function synergistically, for example, as a suction channel, water connection, and/or distributor pipe for the roll cooling in hot strip facilities.

Furthermore, safety devices, such as fire extinguishing devices, can be integrated in the media module.

If applicable, all individual features which are represented in the exemplary embodiments can be combined and/or exchanged with one another without leaving the scope of the invention.

### LIST OF REFERENCE SIGNS

1 media module
1a safety railing
1b access
2 roll stand
10 control unit
11 base plate
11a media transport line
12 functional block
12a internal piping
12b control element
13 fastening screw
20 energy supply device

1-16. (canceled)

17. A control unit for a distributor network of liquid and/or gaseous media for a roll stand, comprising:
a base plate having one or more media transport lines of the distributor network, which extend at least in sections in the plane of the base plate; and
one or more functional blocks having an internal piping and one or more control elements having a functional connection thereto, wherein the functional blocks are configured to be installable on the base plate so that the internal piping has a fluid connection to one or more of the media transport lines, and to be detachable from the base plate.

18. The control unit as claimed in claim 17, wherein the base plate and/or an intermediate plate arranged between the functional blocks and the base plate has multiple openings, which are configured for the screw connection of the functional blocks by fastening screws, preferably lag screws.

19. The control unit as claimed in claim 17, wherein the control elements comprise valves and/or actuating elements thereof.

20. The control unit as claimed in claim 17, wherein the media transport lines comprise one or more supply lines and one or more removal lines, which are configured to transport the corresponding media from a main supply to the functional blocks and from there to consumers.

21. The control unit as claimed in claim 17, wherein the media transport lines are embedded at least in sections in the base plate.

22. The control unit as claimed in claim 17, wherein the base plate and the functional blocks are modularly constructed so that the functional blocks are configurable differently on the base plate.

23. A media module for operating, control, regulation, maintenance, and/or monitoring, of a distributor network of liquid and/or gaseous media for a roll stand, which has one or more control units the one or more control units including a base plate having one or more media transport lines of the distributor network, which extend at least in sections in the plane of the base plate; and one or more functional blocks having an internal piping and one or more control elements having a functional connection thereto, wherein the functional blocks are configured to be installable on the base plate so that the internal piping has a fluid connection to one or more of the media transport lines, and to be detachable from the base plate.

24. The media module as claimed in claim 23, which is configured as a media stage, preferably having a safety railing and an access, via which maintenance personnel can step onto the media stage.

25. The media module as claimed in claim 23, further comprising an energy supply device.

26. The media module as claimed in claim 25, wherein the energy supply device has at least one pump and at least one media container for supplying one or more consumers.

27. The media module as claimed in claim 23, further comprising a hoist, step wedge, sling or installation points for attaching slings, and/or a step tread extension device.

28. The media module as claimed in claim 23, further comprising one or more support crossbeams, which are preferably embodied as hollow girders and function in this case as a suction channel, water connection, and/or distributor pipe for a roll cooling.

29. A roll stand, which has at least one media module the media module operating, control, regulation, maintenance, and/or monitoring, of a distributor network of liquid and/or gaseous media for the roll stand, the media module including one or more control units the one or more control units including a base plate having one or more media transport lines of the distributor network, which extend at least in sections in the plane of the base plate; and one or more functional blocks having an internal piping and one or more control elements having a functional connection thereto, wherein the functional blocks are configured to be installable on the base plate so that the internal piping has a fluid connection to one or more of the media transport lines, and to be detachable from the base plate

30. The roll stand as claimed in claim 29, further comprising one or more roll supports, on which the media module is fastened, preferably above rolls supported by the roll supports.

31. The roll stand as claimed in claim 30, wherein the media module is fastened, preferably screwed on one or more vertical surfaces of the roll support.

32. The roll stand as claimed in claim 29, wherein the media module is fastened on one or more supports which are decoupled from the roll stand.
